(19) United States
(12) Patent Application Publication
(10) Pub. No.: US 2026/0249316 A1
(43) Pub. Date: Aug. 27, 2026

(54) Compound Pressure Sensor for Waterborne Canister System

(71) Applicant: FANUC AMERICA CORPORATION, Rochester Hills, MI (US)

(72) Inventors: Alexandra Critchett, Shelby Twp, MI (US); Ernest Otani, Waterford, MI (US)

(21) Appl. No.: 19/543,175

(22) Filed: Feb. 18, 2026

Related U.S. Application Data
(60) Provisional application No. 63/763,453, filed on Feb. 26, 2025.

(51) Int. Cl. B05B 12/00; B05B 13/04; B25J 11/00; G01M 3/26

(52) U.S. Cl. CPC B05B 12/006; B05B 13/0431; B25J 11/0075; G01M 3/26

(57) ABSTRACT

A system for dispensing paint from a painting robot. The system includes a common line, a paint manifold including a plurality of valves coupled to a source of paint and the common line, a solvent/air manifold including a plurality of valves coupled to a solvent source or an air source and the common line, and a vacuum manifold including a plurality of valves and a vacuum generator coupled to the common line. A compound pressure sensor is positioned in the common line and measures or detects one or more of the pressure of paint in the common line, the pressure of solvent in the common line, air pressure in the common line, vacuum in the common line and paint/solvent/air leaks at different points in time during operation of the system.

### CROSS-REFERENCE TO RELATED APPLICATIONS

This application claims the benefit of U.S. Provisional Application No. 63/763,453, titled Compound Pressure Sensor for Waterborne Canister System, filed Feb. 26, 2025.

### BACKGROUND

### Field

This disclosure relates generally to a fluid dispensing system and, more particularly, to a paint dispensing system including a compound pressure sensor for measuring the pressure of air, paint, solvent and vacuum at different times during operation of the system.

### Discussion of the Related Art

A typical painting station for painting the exterior surfaces of a vehicle body in both continuous conveyance and stop station systems includes a spray booth, a plurality of painting robots and opener/closer robots disposed on a periphery thereof. These robots can be mounted on the floor, the wall, the ceiling or side rails. The painting robots typically include a spray gun or rotary applicator for directing atomized paint onto the vehicle body. The spray booth includes sophisticated environmental and air handling equipment that treats and exhausts the vapor-laden air from the spray booth, and prevents the paint vapors from entering an operator aisle where people are present.

A paint dispensing system is often employed in connection with a painting robot that includes a configuration of valves, chambers, hoses, passageways, devices, and other components that direct paint from a plurality of paint sources to the applicator, direct solvent from one or more solvent sources through the components to clean the dispensing system, direct air from an air source through the components to dry the dispensing system and provide a vacuum to evacuate the passageways. It may be desirable to monitor the solvent pressure to provide an alert if there is a failure in the solvent supply system, such as low or no solvent pressure, which can affect color change effectiveness and electrostatic isolation. It may also be desirable to monitor the air pressure to provide an alert if there is a failure in the air supply system, such as low or no air pressure, which can affect color change effectiveness and electrostatic isolation. It may also be desirable to monitor the paint pressure to provide an alert if there is a failure in the paint supply system, such as low or no paint pressure, which can affect flow accuracy, spray pattern and color change effectiveness. It may also be desirable to monitor vacuum level to ensure evacuation of the passageways.

It is known in the art to employ a pressure sensor to measure the pressure of vacuum in a paint dispensing system. However, the known pressure sensors have a number of drawbacks. These drawbacks include that the location of the pressure sensor does not allow the sensor to effectively monitor positive liquid or air pressure in the passages that deliver paint, solvent and air to a paint dispensing device. Further, the location of the pressure sensor does not allow the sensor to monitor unexpected pressure from a leaking color supply valve, solvent supply valve or air supply valve. Also, the location of the pressure sensor does not allow the sensor to monitor a slow to open or otherwise malfunctioning vacuum valve.

### SUMMARY

The following discussion discloses and describes a system for dispensing paint from a painting robot. The system includes a common line, a paint manifold including a plurality of valves coupled to a source of paint and the common line, a solvent/air manifold including a plurality of valves coupled to a solvent source or an air source and the common line, and a vacuum manifold including a plurality of valves and a vacuum generator coupled to the common line. A compound pressure sensor is positioned in the common line and measures or detects one or more of the pressure of paint in the common line, the pressure of solvent in the common line, air pressure in the common line, vacuum in the common line and paint/solvent/air leaks at different points in time during operation of the system.

Additional features of the present disclosure will become apparent from the following description and appended claims, taken in conjunction with the accompanying drawings.

### BRIEF DESCRIPTION OF THE DRAWINGS

FIG. 1 is an isometric view of a painting robot;

FIG. 2 is a schematic type diagram of a paint dispensing system that can be used with the painting robot shown in FIG. 1;

FIG. 3 is a schematic type diagram of a paint dispensing system that is the same as the paint dispensing system shown in FIG. 2, but without an isolation manifold;

FIG. 4 is a schematic type diagram of a portion of a paint dispensing system illustrating a paint manifold positioned remotely from a paint applicator; and

FIG. 5 is a schematic type diagram of the portion of the paint dispensing system shown in FIG. 4 illustrating the paint manifold coupled to the paint applicator.

### DETAILED DESCRIPTION OF THE EMBODIMENTS

The following discussion of the embodiments of the disclosure directed to a paint dispensing system including a compound pressure sensor for measuring the pressure of air, paint, solvent and vacuum during operation of the system is exemplary in nature, and is in no way intended to limit the invention or its applications or uses. For example, although the discussion herein is specific to a paint dispensing system for a painting robot, the paint dispensing system may have application for dispensing other coatings or fluids by other devices for other applications.

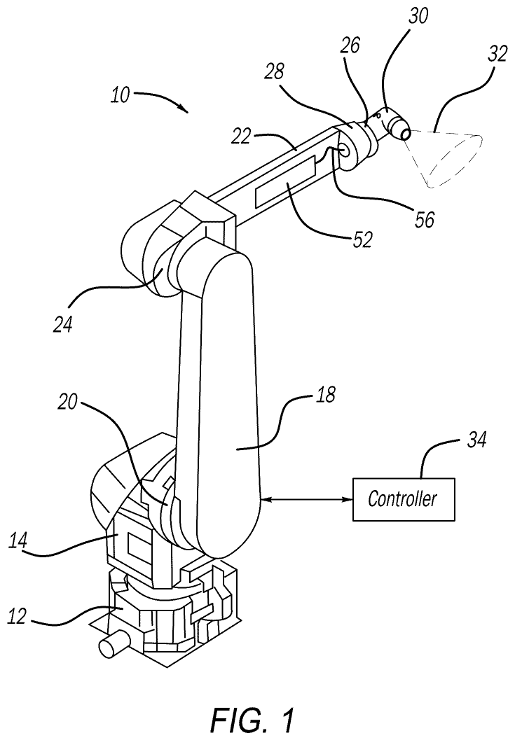

FIG. 1 is an isometric view of a painting robot 10 mounted to a fixed base mounting stand 12, where the robot 10 is intended to represent any painting robot suitable for the purposes discussed herein. A turret or robot base 14 is rotatably mounted to the mounting stand 12. An inner arm 18 is rotatably coupled to the base 14 by a joint 20, an outer arm 22 is rotatably coupled to the inner arm 18 by a joint 24, and a wrist member 26 is rotatably coupled to the outer arm 22 by a joint 28. An applicator 30 is fixedly attached to the wrist member 26 at an angle optimized for a painting application, where paint spray 32 is shown being emitted from the applicator 30. A robot controller 34 controls the robot 10 and is intended to represent all of the computers, devices, software, etc. necessary to do that.

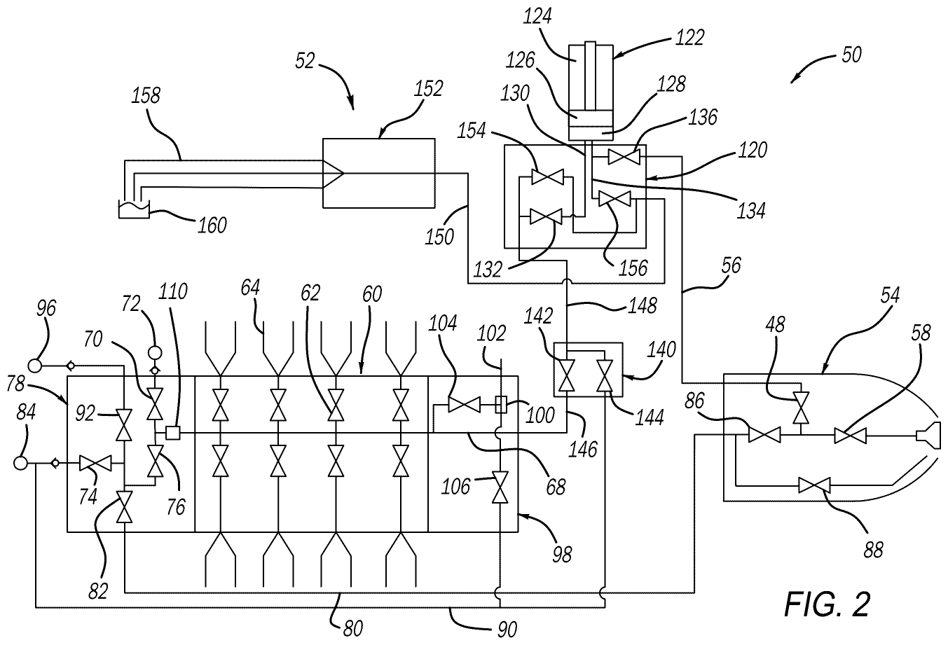

FIG. 2 is a schematic type diagram of a paint dispensing system 50 that can be used with the painting robot 10 shown in FIG. 1. It is noted that although the discussion herein is specific to a painting robot that paints, for example, a vehicle body, the paint dispensing system 50 may have application for dispensing other coatings or fluids by other devices for other applications. The system 50 includes a dispensing sub-system 52 and an applicator 54, such as the applicator 30, for example, a rotary atomizer, having a paint enable valve 48 and a trigger valve 58, that are connected by a paint dispensing line 56. The dispensing sub-system 52 is shown mounted to the outer arm 22 of the robot 10, however, the sub-system 52 can be mounted to other parts of the robot 10 including the inner arm 18. The various paint sources, solvent sources and air sources referred to below would be provided at another location and plumbed to the sub-system 52. The applicator 54 would be part of an end-effector on the robot 10 and be positioned within the spray booth.

The dispensing sub-system 52 includes a paint manifold 60 having a plurality of color valves 62 that are selectively opened to obtain paint from a plurality of paint sources 64 and provide the paint to a central line 68. The dispensing sub-system 52 also includes a solvent/air manifold 78 having a solvent valve 70 that is selectively opened to provide solvent to the central line 68 from a solvent source 72. The solvent/air manifold 78 also includes an air valve 74 that is selectively opened to provide air to the central line 68 through a valve 76 or to a wash line 80 through a valve 82 from an air source 84. The air source 84 also provides air to an air line 90. The solvent/air manifold 78 also includes a solvent valve 92 that is selectively opened to provide solvent to the wash line 80 through the valve 82, or the central line 68 through the valve 76, from a solvent source 96. The wash line 80 is also coupled to a valve 86 and a bell valve 88 in the applicator 54. The dispensing sub-system 52 also includes a vacuum manifold 98 having a venturi vacuum generator 100 coupled to a vacuum exhaust 102 and a valve 104 also coupled to the central line 68. A valve 106 is coupled to the vacuum generator 100 and the air line 90.

The dispensing sub-system 52 also includes a compound pressure sensor 110 positioned in the central line 68. Although the pressure sensor 110 is shown in the solvent/air manifold 78 in this non-limiting embodiment, the pressure sensor 110 can be located at any suitable location along the central line 68, or other locations, that allows the sensor 110 to measure the pressure of the paint supplies, solvent supplies, compressed air supplies and vacuum level depending on what fluid or no fluid is provided on the line 68 at a particular point in time. As will be discussed in detail below, the sensor 110 is capable of reading positive pressure and negative pressure (vacuum) and reporting the pressure measurements to the robot controller 34 where software uses the pressure measurements for system alarms and equipment diagnostics.

The dispensing sub-system 52 further includes a canister manifold 120 having a paint canister 122 attached thereto, where the canister 122 includes a chamber 124. The canister 122 also includes a drive piston 126 defining a paint volume 128 in the chamber 124 therebetween, which holds a predetermined volume of paint when the canister 122 is loaded with paint. The drive piston 126 can be motor driven, pneumatically driven, fluid driven, etc. A fill line 130 allows the paint volume 128 to be filled with paint through a fill valve 132 and a dispense line 134 allows paint to be dispensed from the paint volume 128 by movement of the piston 126 into the paint dispensing line 56 through a paint outlet valve 136.

The paint canister 122 and the applicator 54 are at high voltage and the manifolds 60 and 78 are grounded by a fluid supply during the painting operation. Therefore, the paint canister 122 must be electrically isolated from the manifolds 60 and 78 to prevent ground faults. The dispensing sub-system 52 thus includes an isolation manifold 140 having a valve 142 and a valve 144, where the valve 144 is coupled to the air line 90. In one embodiment, an isolation line 146 is coupled to the valve 142 and the central line 68 and an isolation line 148 is coupled to the valve 142 and the valve 132.

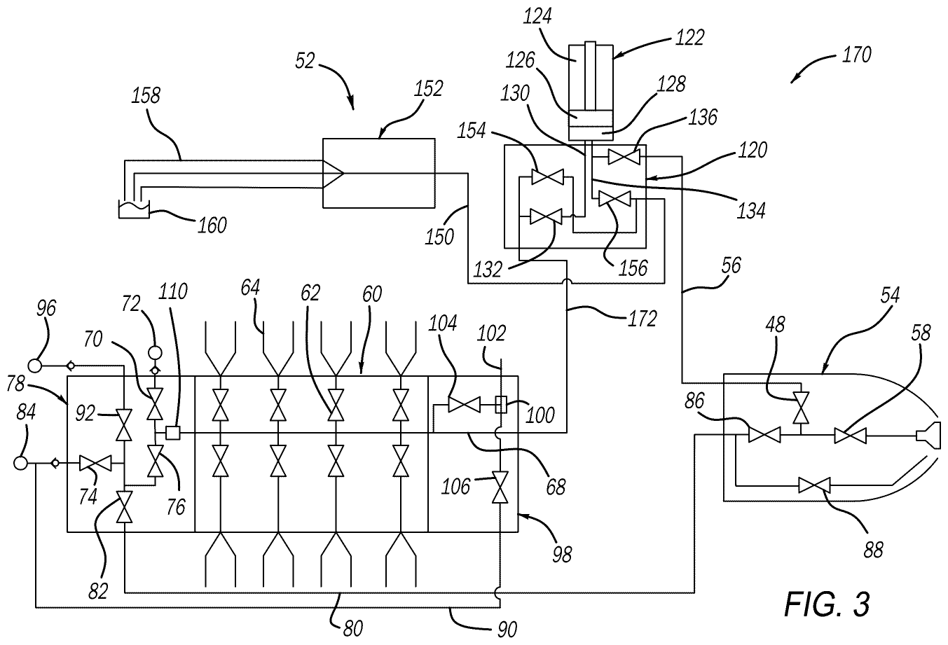

In another embodiment, the central line 68 is directly coupled to the canister manifold 120 with one isolation line. This embodiment is illustrated in FIG. 3 showing a schematic type diagram of a paint dispensing system 170 including an isolation line 172, where like elements to the paint dispensing system 50 are identified by the same reference number.

A dump isolation line 150 is coupled to the canister manifold 120 and a dump manifold 152 so as to allow paint, solvent and air to be dumped from the manifold 120 through dump valves 154 and 156. The dump manifold 152 directs paint, solvent or air onto output lines 158 to a desired receptacle 160.

The compound pressure sensor 110 monitors the pressure in the lines 56, 68, 146 and 148 and all of the passages that are fluidly connected to the lines 56, 68, 146 and 148, passages in the canister manifold 120 and the paint canister 122. Each of these components may contain paint, solvent, air or vacuum at different times during the operational cycle of the dispensing sub-system 52. For example, prior to filling the canister 122, the lines 56, 68, 128, 134 146, 148 and 130 may be evacuated by blowing compressed air from the line 90 through the valve 106 through the venturi vacuum generator 100 and through the exhaust 102 to draw air from the various passages when the valve 104 is opened to expose the passages to vacuum. Other valves also need to be open to fluidly connect the different portions of the system. When this operation occurs, the compound pressure sensor 110 will be exposed to vacuum. For this operation, the sensor 110 can report the vacuum level and the controller 34 can post an alarm or warning if the vacuum pressure is inadequate for the process for any reason.

In another example, during a color change, the canister 122 and the lines 56, 68, 146, 148, 130 and 134 may be filled with paint from one of the paint supply valves 62. For this operation the compound pressure sensor 110 can measure and report the paint pressure supplied by the paint valves 62 and the controller 34 can post an alarm or warning if the paint pressure value is abnormal. The sensor 110 can provide an indication that one of the valves 62, 70, 74, 76, 92 or 144 may be leaking if positive pressure is detected when the central line 68 should be empty. Further, software can collect pressure values from a particular color valve and provide information for statistical process control of paint pressure and reporting statistical abnormalities over time.

In another example, during the portions of the color change operation when solvent is supplied through the valve 70 or the valve 92 the compound pressure sensor 110 can measure and report the pressure of the solvent supplied on the various lines attached thereto that are used to direct the solvent, and the controller 34 can post an alarm or warning if the measured pressure value is abnormal.

Further, like the solvent, air supplied through the air valve 74 can be monitored in the various lines that receive the air by the compound pressure sensor 110 during certain times during the color change process. The controller 34 can post an alarm or warning if the measured pressure value is abnormal. Therefore, the sensor 110 is able to measure or detect one or more of paint pressure in the central line 68, solvent pressure in the central line 68, air pressure in the central line 68, vacuum in the central line 68 and paint/solvent/air leaks at different points in time during operation of the sub-system 52.

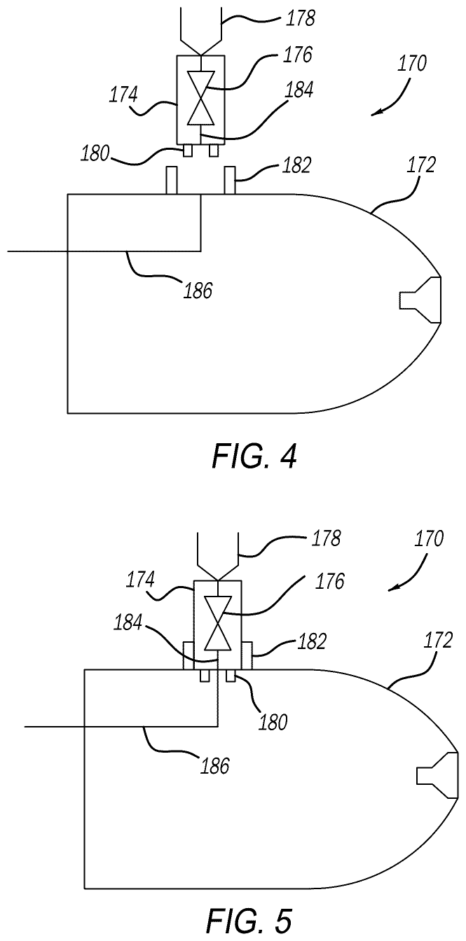

In an alternate embodiment, the paint manifold 60 can be removed from the paint dispensing sub-system 52 and be positioned remotely from the robot 10. The remaining parts of the paint dispensing sub-system 52 discussed above could still be configured within the outer arm 22 of the robot 10. FIGS. 4 and 5 are schematic type diagrams of a portion of a paint dispensing system 170 illustrating this embodiment. The system 170 includes a paint applicator 172 of the type discussed above, where the various valves in the applicator 172 for controlling the flow of paint, solvent and air are not shown. The system 170 further includes a paint manifold 174 shown positioned remotely from the applicator 172 in FIG. 4. The paint manifold 174 would be similar to the paint manifold 60, where a valve 176 represents the plurality of color valves 62 and a paint source 178 represents the plurality of paint sources 64. The paint manifold 174 is positioned proximate to the robot 10 at any suitable location. The robot 10 is controlled to move the applicator 172 to the paint manifold 174 to obtain paint for dispensing.

The paint manifold 174 includes a docking device 180 and the applicator 172 includes a docking port 182 that allows the paint manifold 174 to be coupled to the applicator 172, as shown in FIG. 5. The docking device 180 can be any device suitable for the purposes discussed herein, where many types of devices and designs would be readily apparent to those skilled in the art. For example, the docking device 180 can include various components, such as snap fittings, alignment pins, hoses, pneumatic devices, clamps, suction devices, magnetics, etc. When the paint manifold 174 is coupled to the applicator 172, a paint line 184 in the paint manifold 174 is coupled to various valves and lines (not shown) in the applicator 172 that allow the paint line 184 to be coupled to a paint canister (not shown) similar to the paint canister 122 for dispensing paint out of the applicator 172. Also, when the paint manifold 174 is coupled to the applicator 172, the paint line 184 is positioned in fluid communication with a common line 186 that extends through and out of the applicator 172. The common line 186 is representative of the central line 68 discussed above that is coupled to the solvent manifold 78 and the air manifold 98, and includes the compound sensor 110. Therefore, the sensor 110 is also able to measure or detect one or more of paint pressure in the common line 186, solvent pressure in the common line 186, air pressure in the common line 186, vacuum in the common line 186 and paint/solvent/air leaks at different points in time during operation of the system 170.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A system for dispensing paint, said system comprising:
a common line;
a paint manifold including a plurality of valves coupled to a source of paint and the common line;
a solvent/air manifold including a plurality of valves coupled to a solvent source or an air source and the common line;
a vacuum manifold including a plurality of valves and a vacuum generator coupled to the common line; and
a compound pressure sensor positioned in the common line and measuring or detecting one or more of paint pressure in the common line, solvent pressure in the common line, air pressure in the common line, vacuum in the common line and paint/solvent/air leaks at different points in time during operation of the system.

2. The system according to claim 1 wherein the pressure sensor measures air pressure, solvent pressure, vacuum and paint/solvent/air leaks.

3. The system according to claim 1 wherein the pressure sensor measures vacuum and paint pressure.

4. The system according to claim 1 wherein the pressure sensor measures vacuum and paint/solvent/air leaks.

5. The system according to claim 1 wherein the pressure sensor measures vacuum, air pressure and solvent pressure.

6. The system according to claim 1 wherein the system is part of a painting robot.

7. A system for dispensing paint, said system comprising:
a common line;
a paint manifold including a plurality of valves coupled to a source of paint, said paint manifold being removably coupled to the common line;
a solvent/air manifold including a plurality of valves coupled to a solvent source or an air source and the common line;
a vacuum manifold including a plurality of valves and a vacuum generator coupled to the common line; and
a compound pressure sensor positioned in the common line and measuring or detecting one or more of paint pressure in the common line, solvent pressure in the common line, air pressure in the common line, vacuum in the common line and paint/solvent/air leaks at different points in time during operation of the system.

8. The system according to claim 7 wherein the pressure sensor measures air pressure, solvent pressure, vacuum and paint/solvent/air leaks.

9. The system according to claim 7 wherein the pressure sensor measures vacuum and paint pressure.

10. The system according to claim 7 wherein the pressure sensor measures vacuum and paint/solvent/air leaks.

11. The system according to claim 7 wherein the pressure sensor measures vacuum, air pressure and solvent pressure.

12. The system according to claim 7 wherein the system is part of a painting robot.

13. The system according to claim 12 wherein the painting robot includes a paint applicator, said painting manifold being removably coupled to the applicator.

14. A robot assembly including a painting robot and a paint dispensing system, said paint dispensing system comprising:
a common line;
a paint manifold including a plurality of valves coupled to a source of paint, said paint manifold being statically or removably coupled to the common line;
a solvent/air manifold including a plurality of valves coupled to a solvent source or an air source and the common line;
a vacuum manifold including a plurality of valves and a vacuum generator coupled to the common line; and
a canister manifold including a plurality of valves;
a fluid canister coupled to the canister manifold and having a chamber therein, said plurality of valves in the canister manifold being coupled to the common line so as to allow paint, solvent, air and vacuum to be provided to the chamber; and
a compound pressure sensor positioned in the common line and measuring or detecting one or more of paint pressure in the common line, solvent pressure in the common line, air pressure in the common line, vacuum in the common line and paint/solvent/air leaks at different points in time during operation of the dispensing system.

15. The robot assembly according to claim 14 wherein the pressure sensor measures air pressure, solvent pressure, vacuum and paint/solvent/air leaks.

16. The robot assembly according to claim 14 wherein the pressure sensor measures vacuum and paint pressure.

17. The robot assembly according to claim 14 wherein the pressure sensor measures vacuum and paint/solvent/air leaks.

18. The robot assembly according to claim 14 wherein the pressure sensor measures vacuum, air pressure and solvent pressure.

19. The robot assembly according to claim 14 wherein the painting robot includes a paint applicator, said painting manifold being removably coupled to the applicator.
